(19) United States
(12) Patent Application Publication
(10) Pub. No.: US 2005/0085217 A1
(43) Pub. Date: Apr. 21, 2005

(54) Method for setting shortcut key and performing function based on fingerprint recognition and wireless communication terminal using thereof

(76) Inventor: Chae-Yi Lim, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/968,744

(22) Filed: Oct. 19, 2004

(30) Foreign Application Priority Data
Oct. 21, 2003 (KR) 2003-73405
May 31, 2004 (KR) 2004-39185

(51) Int. Cl. H04M 1/66

(52) U.S. Cl. 455/410; 455/575.1

(57) ABSTRACT

A method for setting a shortcut key and performing a function based on fingerprint recognition is disclosed. The method includes the steps of: a) activating a fingerprint registering menu according to a request signal of setting a shortcut key; b) selecting a telephone number for setting the shortcut key to make a call when the request signal is a call request signal; c) receiving a fingerprint data from a fingerprint scanning unit by activating the fingerprint scanning unit; and d) storing the setting of the shortcut key including the selected telephone number and the received fingerprint data.

### RELATED APPLICATIONS

This application claims the benefit under 35 U.S.C. § 119 to Korean Patent Application No. 2003-73405 filed Oct. 21, 2003, and Korean Patent Application No. 2004-39185 filed May 31, 2004, which are hereby incorporated herein by reference in their entirety.

### BACKGROUND OF THE INVENTION

1. Field of the Invention

The present invention relates to a wireless communication terminal and a method for setting a shortcut key and performing a function based on a fingerprint recognition; and, more particularly, to a wireless communication terminal and a method for setting a shortcut key to perform the predetermined function with a scanned fingerprint, and performing the predetermined function set to the shortcut key by receiving an identical fingerprint to the scanned fingerprint.

2. Description of Related Arts

Hereinafter, a wireless communication terminal is a portable terminal capable to communicate with other terminals through a wireless communication link such as a personal communication station, a personal digital assistance, a smart phone and a next generation mobile communication terminal capable of processing data based on an international mobile telecommunication (IMT)-2000.

Also, a shortcut key is a key or key combination used to perform a defined function in applications. Usually, the wireless communication terminal provides a plurality of shortcut keys for easily performing the predetermined functions.

Generally, a fingerprint is an impression of the underside of the end of a finger or a thumb. That is, the fingerprint is a certain arrangement of ridges formed by protuberance of perspiratory glands. The fingerprint has been known to have two important characteristics as follows. The arrangement of ridges in any fingerprint is thought to be unique. That is, no two persons have the same fingerprints. Also, the arrangement of ridges in the fingerprint is permanent. That is, one's fingerprint is not changed from birth to death. Accordingly, many scientists have been studied a technology of recognition of fingerprint to use the fingerprint as identification since middle of years 1800.

The technology for fingerprint recognition has superior performance in a view of processing speed and accuracy comparing to other technologies such as retina recognition, iris recognition, a blood vessel recognition and a visage recognition because of fingerprint recognition's unique and permanent characteristics. Also, the technology for fingerprint recognition is known as the most effective technology of identification in views of a cost, a performance, a convenience and a market.

A device for scanning the fingerprint has been categorized in an optical scanning device and a non-optical scanning device. The optical scanning device scans the fingerprint by using a reflection of a light. In other hands, the non-optical scanning device uses an ultra sonic wave and scans the fingerprint based on a pressure and a heat of a finger.

The optical scanning device generally includes an emitting unit, a lens and a camera for scanning the fingerprint of a predetermined finger. Accordingly, a size of the optical scanning device may be large and expensive. In the mean time, the optical scanning device is generally durable from external impacts or scratches and also is reliable.

A size of the non-optical scanning device may be small and the non-optical scanning devices are constructed as one semiconductor chip. Therefore, the non-optical scanning device can be manufactured in mass production. However, it is very sensitive to an external environment such as external impact, electrostatics, temperature and humidity.

At 1901, Edward Henry applies the technology of fingerprint recognition to identify railway workers for managing salary of the railway workers. And a live-scan system is developed at late in 1960s. The live-scan system scans the fingerprint, generates an electronic image of the fingerprint and converts the electronic image of the fingerprint to binary data. After introducing the live-scan system, a technology for building a database of huge number of electronic images of fingerprints and automated fingerprint identification have been actively developed. At early in 1990s, various applications of the automated fingerprint identification technologies have been spotlighted and developed according to rapid development of computer communication technology.

As mentioned above, the fingerprint has been used for recognizing one's identification for such a long time. According to rapid development of computer communication network, security and protection of privacy have been seriously considered and the automated fingerprint identification technology has been most effective solution for security and protection issues as a method for authenticating one's identification. Also, a scanning sensor of fingerprint has been compactly integrated by development of fingerprint identification technology and the integrated scanning sensor is widely applied in an electrical commerce of the computer network.

Recently, the fingerprint recognizing technology is applied not only in a field of network security system such as security of database and electrical commerce, but also in a portable electric device such as a notebook computer, a wireless communication terminal and a personal data assistance (PDA).

However, the fingerprint recognizing technology applied into the portable electric device is used for security of data, verification of electric commerce and controlled entrance or controlled access. It is not used for personal convenience and entertainment.

### SUMMARY OF THE INVENTION

It is, therefore, an object of the present invention to provide a method for setting shortcut keys of a wireless communication terminal based on a plurality of fingerprint data from a fingerprint scanning sensor and a wireless communication terminal using thereof.

It is another object to the present invention to provide a method for performing functions of the wireless communication terminal corresponding shortcut keys set based on a plurality of fingerprint data from a fingerprint scanning sensor and a wireless communication terminal using thereof.

In accordance with an aspect of the present invention, there is provided a method for setting a shortcut key based on fingerprint recognition, the method including the steps of: a) activating a fingerprint registering menu according to a request signal of setting a shortcut key; b) selecting a telephone number for setting the shortcut key to make a call when the request signal is a call request signal; c) receiving a fingerprint data from a fingerprint scanning unit by activating the fingerprint scanning unit; and d) storing the setting of the shortcut key including the selected telephone number and the received fingerprint data.

In accordance with another aspect of the present invention, there is provided a method for setting a shortcut key based on fingerprint recognition, the method including the steps of: a) selecting one of telephone numbers in a list for setting a shortcut key to make a call to the selected telephone number; b) activating a fingerprint registering menu according to a request signal of setting a shortcut key; c) receiving a fingerprint data from a fingerprint scanning sensor by activating the fingerprint scanning sensor; and d) storing a setting of the shortcut key including the selected telephone number and the received fingerprint data.

In accordance with still another aspect of the present invention, there is provided a method for setting a shortcut key based on fingerprint recognition, the method including the steps of: a) displaying functions in a menu according to a menu selection signal and selecting a predetermined function in the menu for setting a shortcut key to perform the predetermined function; b) activating a fingerprint registering menu according to a request signal of setting the shortcut key; c) receiving a fingerprint data from a fingerprint scanning unit by activating the fingerprint scanning unit; and d) storing the setting of the shortcut key including the selected predetermined function with the received fingerprint data.

In accordance with further still another aspect of the present invention, there is provided a method for setting a shortcut key based on fingerprint recognition, the method including the steps of: a) receiving a fingerprint data from a fingerprint scanning unit when a call request signal is received; b) finding a fingerprint data identical to the received fingerprint data by comparing the received fingerprint data with stored fingerprint data in a memory; and c) establishing a call connection based on the telephone number set to the stored fingerprint data identical to the received fingerprint data.

In accordance with further still another aspect of the present invention, there is provided a method for setting a shortcut key based on fingerprint recognition, the method including the steps of: a) determining whether a fingerprint data is received from a fingerprint scanning unit when a call request signal is received in a locking mode; b) receiving a secret code from an input unit when the fingerprint data is not received, comparing the received secret code with a pre-stored secret code in a memory and displaying a list of telephone numbers when the received secret code is identical the pre-stored secret code; c) finding a fingerprint data identical to the stored fingerprint data in the memory by comparing the received fingerprint data with stored fingerprint data when the fingerprint data is received; and d) establishing a call connection to a telephone number set to the stored fingerprint data identical to the received fingerprint data.

In accordance with further still another aspect of the present invention, there is provided a method for setting a shortcut key by using fingerprint recognition, the method including the steps of: a) receiving a fingerprint data from a fingerprint scanning unit; b) finding a fingerprint data identical to the received fingerprint data among stored fingerprint data in a memory when a call request signal is received by comparing the received fingerprint data to stored fingerprint data in the memory; and c) establishing a call connection by dialing a telephone number set to the found fingerprint data which is identical to the received fingerprint data among the stored fingerprint data.

In accordance with further still another aspect of the present invention, there is provided a wireless communication terminal for setting a shortcut key based on fingerprint recognition, the wireless communication terminal including: an input unit for receiving a request for setting a shortcut key based on fingerprint recognition; a fingerprint scanning unit for scanning a fingerprint of a predetermined finger and generating a fingerprint data based on the scanned fingerprint; a storing unit for storing a setting of a shortcut key including the fingerprint data received from the fingerprint scanning a and a predetermined function; and a controlling unit for activating a fingerprint registering menu according to the request from the input unit, selecting a predetermined telephone number to be set to the shortcut key when the request is a call request, set the shortcut key to match the selected telephone number with the fingerprint data received from the fingerprint unit and storing a setting of the shortcut key including the selected telephone number with the fingerprint data received from the fingerprint scanning unit.

In accordance with further still another aspect of the present invention, there is provided a wireless communication terminal for performing a predetermined function based on fingerprint recognition, including: an input unit for receiving a request signal from a button; a fingerprint scanning unit for scanning a fingerprint of a predetermined finger and generating a fingerprint data based on the scanned fingerprint; a storing unit for storing settings of shortcut keys corresponding a plurality of fingerprint data received from the fingerprint scanning unit; and a controlling unit for activating the fingerprint scanning unit when the request signal from the input unit is a call request, receiving a current scanned fingerprint data from the fingerprint scanning unit, and performing a shortcut key set to a fingerprint data stored in the storing unit, which is identical to the current scanned fingerprint data, to make a call by dialing a telephone number set to the shortcut key.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a diagram illustrating a wireless communication terminal including a fingerprint scanning sensor for fingerprint recognition in accordance with a preferred embodiment of the present invention;

FIG. 2 is another diagram showing a wireless communication terminal 100 in FIG. 1;

FIG. 3 is a diagram showing fingers of a hand for explaining a method for setting shortcut keys and performing a predetermined function based on fingerprint recognition in accordance with a preferred embodiment of the present invention;

FIG. 4 is a flowchart for explaining a method of setting a shortcut key and performing a function based on fingerprint recognition in accordance with a preferred embodiment of the present invention;

FIG. 5 is a detailed flowchart for explaining a method of setting a shortcut key and performing a function based on fingerprint recognition in accordance with a preferred embodiment of the present invention;

FIG. 6A is a flowchart showing a method for setting a shortcut key based on fingerprint recognition in accordance with another embodiment of the present invention;

FIG. 6B is a flowchart illustrating a method for setting a shortcut key based on fingerprint recognition in accordance with still another embodiment of the present invention;

FIG. 7 is a flowchart showing a method for setting a shortcut key by using fingerprint recognition in further still another embodiment of the present invention;

FIG. 8 is a flowchart showing a method for setting a shortcut key based on fingerprint recognition in further still another embodiment of the present invention; and

FIG. 9 is a flowchart showing a method for setting a shortcut key based on fingerprint recognition in accordance with a further still another preferred embodiment of the present invention.

### DETAILED DESCRIPTION OF THE INVENTION

Hereinafter, method for setting a shortcut key and performing a function based on fingerprint recognition in accordance with a preferred embodiment of the present invention will be described in more detail with reference to the accompanying drawings.

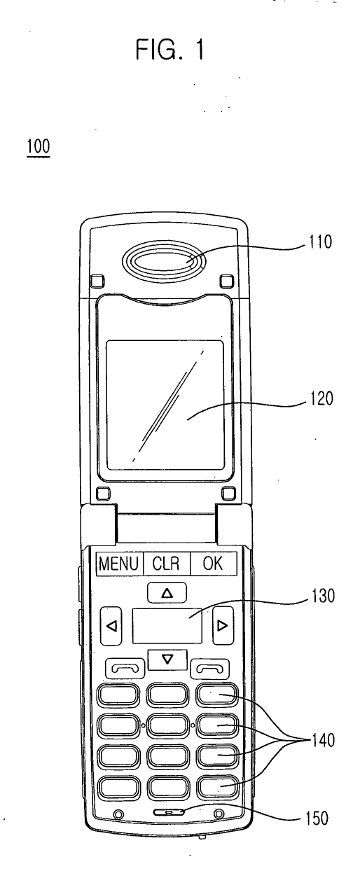

FIG. 1 is a diagram illustrating a wireless communication terminal including a fingerprint scanning sensor for fingerprint recognition in accordance with a preferred embodiment of the present invention.

As shown in FIG. 1, the wireless communication terminal 100 includes an audio output unit (speaker) 110, a display (LCD) 120, an input unit (key pad) 140, and an audio input device (mike) 150. The wireless communication terminal 100 further includes a fingerprint scanning sensor 130. The fingerprint scanning sensor 130 scans a fingerprint of a predetermined finger of a user and converts the scanned fingerprint into a digital image of fingerprint data. Based on the scanned fingerprint data, shortcut keys of the wireless communication terminal 100 are set to perform a predetermined function with the scanned fingerprint data. After setting the shortcut key, the predetermined function is performed whenever the fingerprint scanning sensor scans a fingerprint identical to the scanned fingerprint data set to the predetermined function.

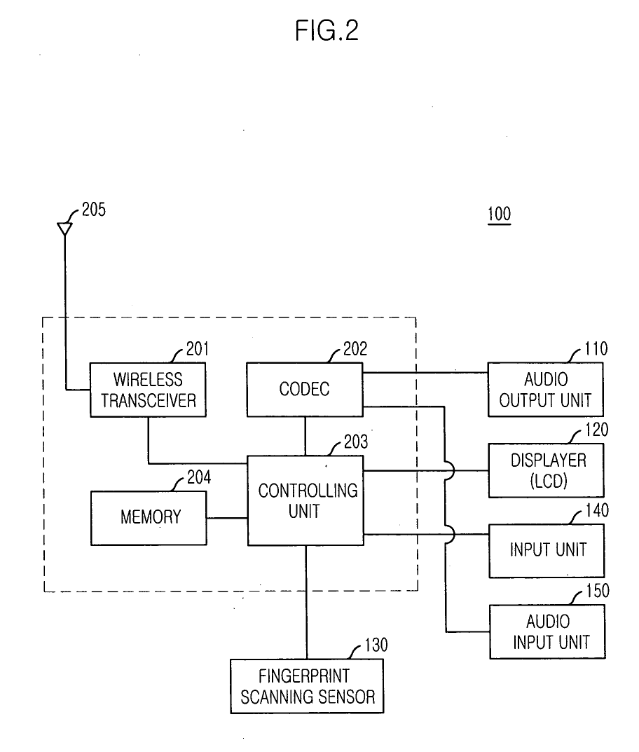

FIG. 2 is another diagram showing a wireless communication terminal 100 in FIG. 1.

Referring to FIG. 2, the wireless communication terminal 100 includes a wireless transceiver 201, a compression/decompression (CODEC) 202, a controlling unit (CPU) 203, a memory 204, a fingerprint scanning sensor 130, an audio output unit 110, a displayer (LCD) 120, an input unit (key pad) 140 and an audio input device 150.

The wireless transceiver 201 receives and transmits signals through an antenna 205.

The controlling unit 203 generally controls operations of the wireless communication terminal 100. Also, the controller 203 controls devices and operations for scanning a fingerprint of a user by using the fingerprint scanning sensor 130 by receiving a request of setting shortcut keys from a user, setting the shortcut key to perform a predetermined function corresponding to the scanned fingerprint data from the fingerprint scanning sensor 130, storing the settings of shortcut keys, performing the predetermined functions when the fingerprint scanning sensor 130 receives a fingerprint data identical to the stored fingerprint data set to the predetermined function. The controlling unit 203 includes a central processing unit (CPU).

The CODEC 202 converts a receiving signal from the wireless transceiver 201 to a voice signal and outputs the voice signal to the audio output unit 110. The CODEC 202 also converts the voice signal received from the audio input unit (mike) 150 to a transmitting signal to be transmitted to the transceiver 201.

The memory 204 stores programs driving the wireless communication terminal, a fingerprint recognition program, scanned fingerprint data and settings of shortcut keys based on the scanned fingerprint data.

The audio output unit 110 outputs the voice signal from the CODEC 202.

The displayer 120 displays data according to the controlling unit 203.

The input unit 140 is an interface between the wireless communication terminal and a user for receiving key inputs from the user.

The audio input unit 150 receives the voice signal from a user and transmits the received voice signal to the CODEC 202.

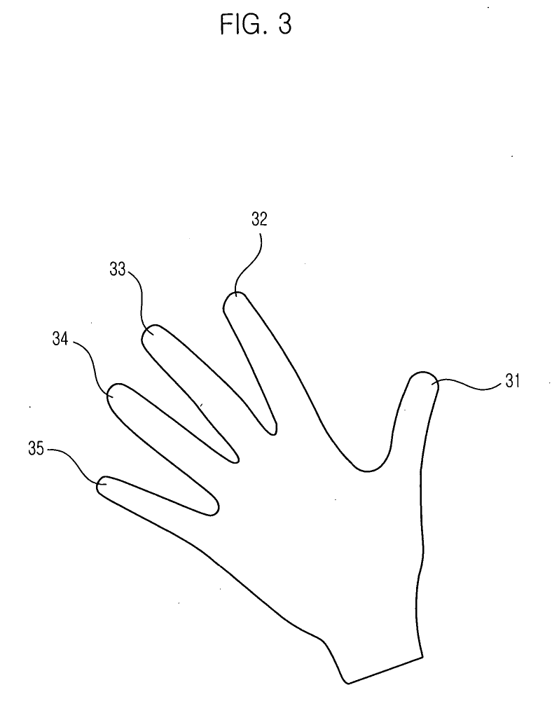

FIG. 3 is a diagram showing fingers of a hand for explaining a method for setting shortcut keys and performing a predetermined function based on fingerprint recognition in accordance with a preferred embodiment of the present invention.

At first, shortcut keys of the wireless communication terminal are previously set to perform predetermined functions corresponding to a plurality of fingerprint data scanned from each of fingers. For example, when a user requests to set a shortcut key of the wireless communication terminal, a fingerprint scanning sensor is activated and scans a thumb 31 to generate a first fingerprint data. After obtaining the first fingerprint data, a first shortcut key is set to perform a function of shortcut message service (SMS) by receiving the first fingerprint data from the fingerprint scanning sensor and the setting of the first shortcut key is stored in the memory. After setting, if the thumb is scanned by the fingerprint scanning sensor and the currently scanned fingerprint data is transferred to the controlling unit of the wireless communication terminal, the controlling unit selects the setting of first shortcut key by comparing the currently scanned fingerprint data with stored fingerprint data in the memory, and performs the function of SMS function by comparing the stored first scanned data and the newly scanned data.

According to the method as mentioned above, fingerprints of other fingers 32, 33, 34 and 35 can be scanned and used for setting a plurality of shortcut keys to perform various functions for making a call to other party or for using other provided functions rather than calling to other party.

In here, functions set to the shortcut keys are a function for selecting a predetermined function in a menu or for dialing a predetermined telephone numbers to make a new call to other party.

Furthermore, various modes may be previously defined and various functions of the wireless communication terminal may be set to each fingerprint of fingers based on the defined modes. The defined modes can be defined as a menu key, a send key(dialing key), a wireless application protocol (WAP) access key.

Moreover, multi-step shortcut keys can be set to perform predetermined functions based on the defined modes by setting firstly scanned fingerprint for selecting a predefined mode and setting secondly scanned fingerprint for performing a predetermined function in the selected predefined mode.

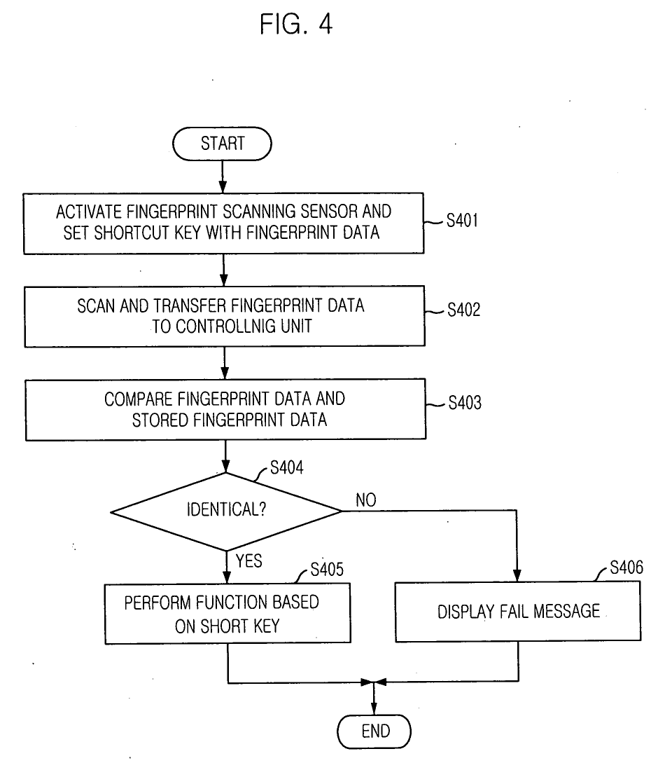

FIG. 4 is a flowchart for explaining a method of setting a shortcut key and performing a function based on fingerprint recognition in accordance with a preferred embodiment of the present invention.

As shown, a controlling unit 203 of a wireless communication terminal 100 activates a fingerprint scanning sensor 130 when the controlling unit 203 receives a request for setting the shortcut key, and receives a plurality of scanned fingerprint data from the fingerprint scanning sensor 130. After receiving the plurality of scanned fingerprint data, shortcut keys are set to perform a plurality of predetermined functions based on the plurality of scanned fingerprint data and the settings of the shortcut keys are stored at the step S401. The predetermined functions can be selected according to a preference of the use or a convenience of usage.

After setting the shortcut keys, the fingerprint scanning sensor 130 scans a fingerprint to generate a current scanned fingerprint data and transfers the current scanned fingerprint data to the controlling unit 203 at step S402. The controlling unit 203 compares the plurality of fingerprint data stored in the memory 204 to the current scanned fingerprint data at step S403.

The controlling unit 203 determines whether there is a fingerprint data stored in the memory which is identical to the current scanned fingerprint data at step S404.

If there is the identical fingerprint data, a setting of shortcut key corresponding to the identical fingerprint data is selected and a function of the selected shortcut key is performed at step S405.

If there is not, the controlling unit 203 displays a message of failing to perform a shortcut key to a displayer 120 of the wireless communication terminal 100 at step S406.

By using the wireless communication terminal 100 having the above mentioned fingerprint scanning sensor 130, the wireless communication terminal 100 can provide not only to set a shortcut key based on fingerprint recognition for convenience but also to prevent unauthorized use of the wireless communication terminal.

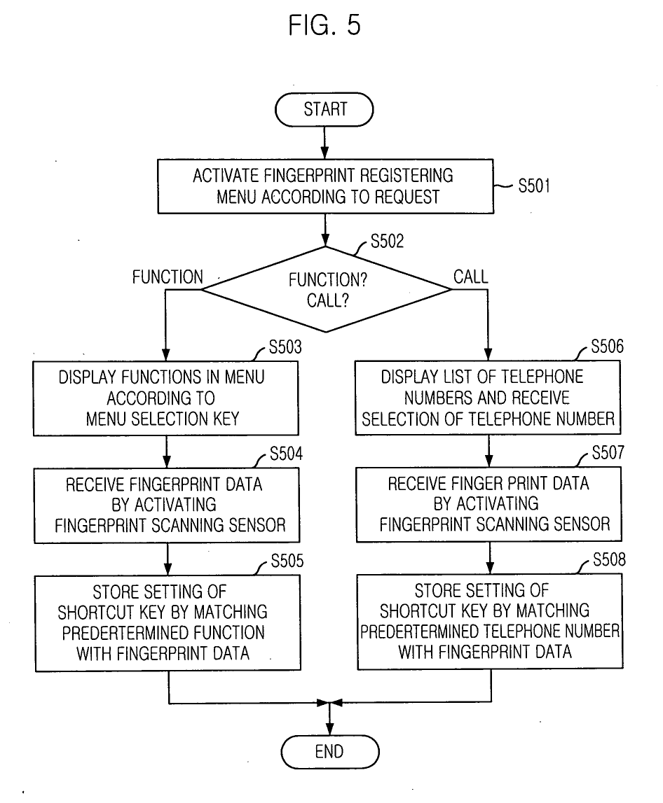

FIG. 5 is a detailed flowchart for explaining a method of setting a shortcut key and performing a function based on fingerprint recognition in accordance with a preferred embodiment of the present invention.

As shown, a controlling unit 203 of the wireless communication terminal 100 activates a fingerprint scanning sensor 130 when a user requests setting a shortcut key at step S501. After activating the fingerprint scanning sensor 130, the controlling unit 203 determines whether the user wants to set a shortcut key for making a call to a predetermined party or for performing a predetermined function beside of making a call based on an input signal from an input unit at step S502.

If the user wants to set a shot key to a predetermined function, a menu is displayed on a displayer 120 of the wireless communication terminal 100 according to a menu selection signal and the predetermined function in the menu is selected for setting the shortcut key at step S503. The step S503 may further include a step for displaying images of fingerprints set to predetermined functions in the menu. The above mentioned additional step may provides a convenience to a user for recognizing previous settings of shortcut keys by displaying images of fingerprint matched with predetermined functions when there are the previous settings of shortcut keys.

After receiving selection of predetermined function in the menu, a fingerprint data is received from the activated fingerprint scanning sensor 130 at step S504 and the selected function in the menu is stored in a memory with the received fingerprint data.

At the step 502, if the user wants to set a shortcut key for making a call to a predetermined party, a list of telephone numbers is displayed at the displayer 120 of the wireless communication terminal 100 and a predetermined telephone number in the list is selected at step S506. The step S506 may further includes a step for displaying images of fingerprints previously set to telephone numbers in the list. The above mentioned additional step may provide a convenience to a user for recognizing previous settings of shortcut keys by displaying images of fingerprints matched with telephone numbers when there are the previous settings of shortcut keys for making a call.

Furthermore, in this step, the predetermined telephone number can be set to the shortcut key either of selecting the telephone number from the list or directly inputting to the wireless communication terminal 100 by using the input unit 140 of the wireless communication terminal 100.

After selecting the telephone number, a fingerprint data is received from the activated fingerprint scanning sensor 130 at step S507 and the setting of the shortcut key is stored in the memory 204 with the selected telephone number and the received fingerprint data at step S508.

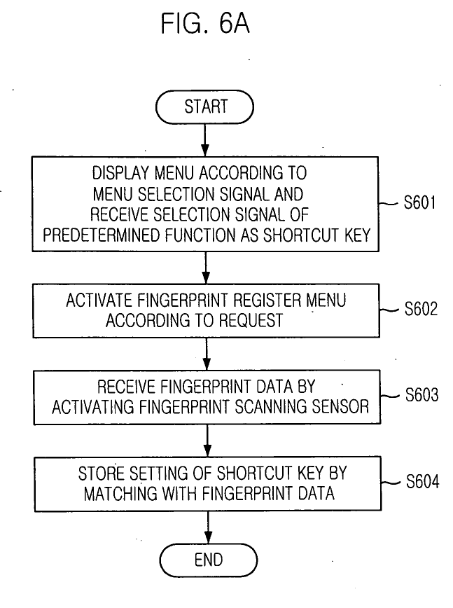

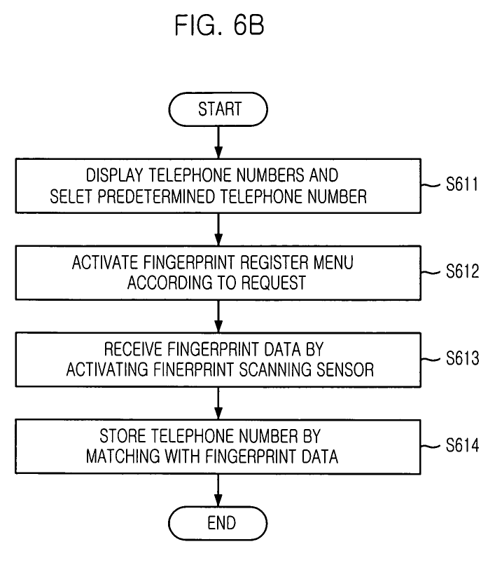

FIG. 6A is a flowchart showing a method for setting a shortcut key based on fingerprint recognition in accordance with another embodiment of the present invention.

As shown in FIG. 6A, a controlling unit 203 displays a menu according to a menu selection signal and a predetermined function in the menu is selected for setting the shortcut key at step S601.

The step S601 may further includes a step for displaying image of fingerprint data previously set to functions in the menu. The above mentioned additional step may provide a convenience to a user for recognizing previous settings of shortcut keys.

After selecting the predetermined function, the controlling unit 203 activates a fingerprint registering menu according to a shortcut key requesting signal at step S602 and a fingerprint data is received from a fingerprint scanning sensor 130 by activating the fingerprint scanning sensor 130 at step S603. A shortcut key is set by matching the predetermined function and the received fingerprint data and the setting of the shortcut key is stored in a memory at step S604.

FIG. 6B is a flowchart showing a method for setting a shortcut key based on fingerprint recognition in still another embodiment of the present invention.

Referring to FIG. 6B, a controlling unit 203 of the wireless communication terminal 100 displays a list of telephone numbers on a displayer 120 of the wireless communication terminal 100 according to a telephone number display requesting signal and a predetermined telephone number in the list is selected at step S611.

The step S611 may further includes a step for displaying images of fingerprint data previously set to telephone numbers in the list. The above mentioned additional step may provide a convenience to a user for recognizing previous settings of shortcut keys by displaying images of fingerprint data matched with telephone numbers when there are the previous settings of shortcut keys for making a call.

After selecting the predetermined telephone number, a fingerprint registering menu is activated according to a shortcut key requesting signal at step S612 and a fingerprint data is received from a fingerprint scanning sensor 130 by activating the fingerprint scanning sensor 130 at step S613. A shortcut key is set to making a call to the predetermined telephone number by matching the predetermined telephone number with the received fingerprint data and the setting of the shortcut key is stored in a memory 204 at step S614.

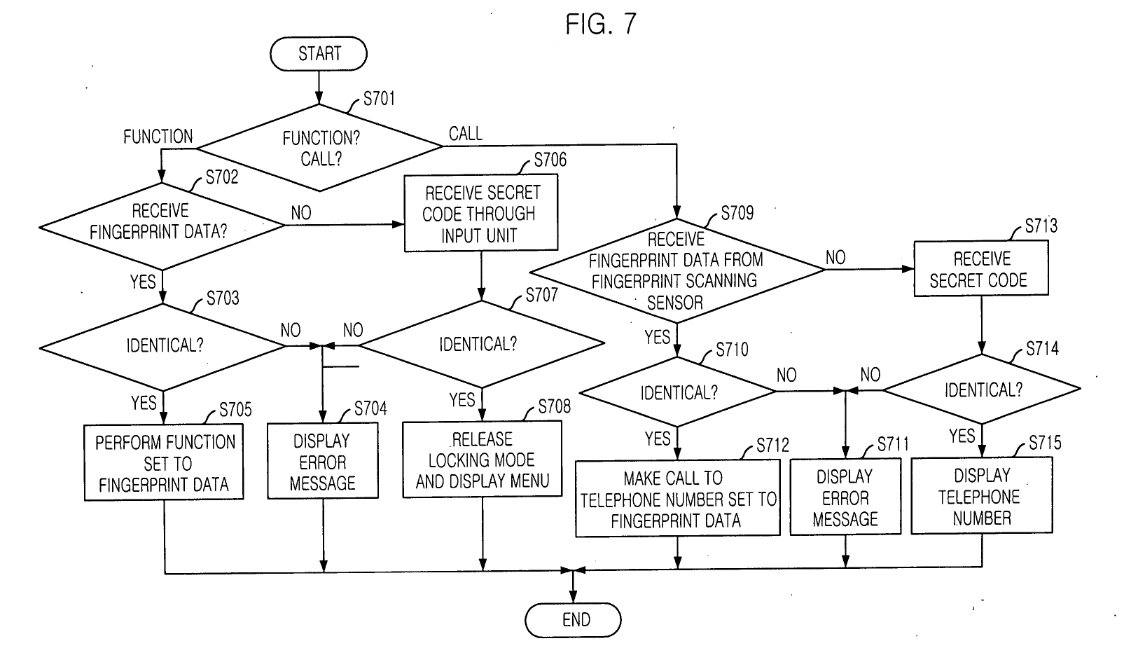

FIG. 7 is a flowchart showing a method for setting a shortcut key by using fingerprint recognition in further still another embodiment of the present invention.

By referring to FIG. 7, a procedure of setting a shortcut key within in a locking mode is explained hereinafter.

At first, a controlling unit 203 of a wireless communication terminal 100 determines whether a request signal for setting a shortcut key is a function request signal representing setting a predetermined function with a fingerprint data or a call request signal representing setting a predetermined telephone number with a fingerprint data at step S701.

If the request signal is the function request signal, it determines whether a fingerprint data is received from a fingerprint scanning sensor 130 at step S702.

The step S702 may further include a step for displaying images of fingerprint data previously set to functions in the menu. A reason of displaying images of fingerprints is explained in later.

If the fingerprint data is received from the fingerprint scanning sensor 130, it determines whether there is a fingerprint data previously stored in the memory identical to the received fingerprint data at step S703.

If there is no identical fingerprint data, an error message is displayed for informing that no fingerprint data matched with the received fingerprint data at step S704.

If there is an identical fingerprint data matched with the received fingerprint data at step S703, a function set to the identical fingerprint data is performed at step S705.

If the fingerprint data is not received from the fingerprint scanning sensor 130 at step S702, a secret code is received from the input unit at step S706.

At step S707, it determines whether the received secret code is matched with a previously stored secret code at step S707.

If the stored secret code and the received secret code are identical, the locking mode is released and a menu is displayed on the displayer of the wireless communication terminal at step S708.

If the stored secret code and the received secret code are not identical, an error message is displayed at the displayer 120 at step S704.

If the request signal is the call request signal at step S701, it determines whether a fingerprint data is received from the fingerprint scanning sensor 130 at step S709.

The step S709 may include a step for displaying a list of telephone numbers with corresponding fingerprint data by selecting the call request signal. A reason for displaying the list with the fingerprint data is explained in later.

If the fingerprint data is received at step S709, it determines whether there is an identical fingerprint data matched with the received fingerprint data at step S710.

If there is no identical fingerprint at step S710, an error message is displayed at a displayer 120 of the wireless communication terminal 100 for noticing there is no identical fingerprint stored in the memory, which is matched with the received fingerprint data at step S711.

If there is the identical fingerprint stored in the memory at step S710, a call connection is established to the telephone number set to the identical fingerprint data by dialing the telephone number set to the identical fingerprint data at step S712.

If the fingerprint data is not received from the fingerprint scanning sensor 130 at step S709, a secret code is received from the input unit at step S713.

After receiving the secret code, it determines whether the received secret code is identical to a stored secret code in a memory 204 at step S714.

If the received secret code is identical to the stored secret code at step S714, the locking mode is released and the list of telephone numbers is displayed at the displayer 120 of the wireless communication terminal 100 at step S715.

If the received secret code is not matched with the stored secret code at step S714, an error message is displayed at the displayer 120 for noticing mismatch of secret code at step S711.

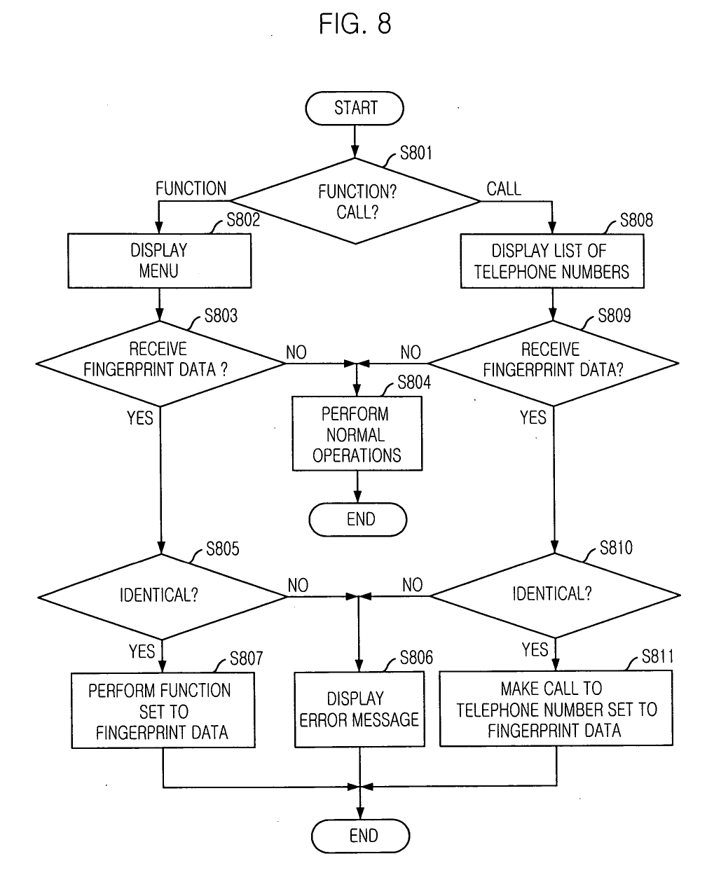

FIG. 8 is a flowchart showing a method for setting a shortcut key based on fingerprint recognition in further still another embodiment of the present invention.

Referring to FIG. 8, a procedure of setting the shortcut key without a locking mode is explained.

At first, a controlling unit 203 of a wireless communication terminal 100 determines whether a request signal for setting a shortcut key is a function request signal representing setting a predetermined function with a fingerprint data or a call request signal representing setting a predetermined telephone number with a fingerprint data at step S801.

If the received request signal is the function request signal at the step S801, functions in a menu and images of fingerprint data set to the functions are displayed at a displayer 120 of the wireless communication terminal 100 at step S802. The step S802 is not essential step of the present invention. The step S802 may provide a convenience to a user for easily indicating one of fingers in order to perform a desired function. However, the step S802 is not necessary step for setting the shortcut key because if the user remembers functions with matched fingerprints then the step S802 may not necessary to be performed.

After displaying the functions with corresponding images of fingerprint data, it determines whether a fingerprint data is received from a fingerprint scanning sensor at step S803.

If the fingerprint data is not received from the fingerprint scanning sensor 130 at step S803, a normal operation of the wireless communication terminal is performed at step S804.

If the fingerprint data is received at step S803, it determines whether there is a fingerprint data stored in the memory identical to the received fingerprint data at step S805.

If there is no stored fingerprint data identical to received fingerprint data at the step S805, an error message is displayed at a displayer 120 of the wireless communication terminal 100 for informing there is no matched fingerprint data at step S806.

If there is a fingerprint data identical to the received fingerprint data in the memory 204 at the step S805, a function set to the identical fingerprint data is performed at step S807.

If the request signal is the call request signal at the step S801, a list of telephone number and corresponding images of fingerprint data are displayed at the displayer 120 of the wireless communication terminal 100 at step S808. The step S808 is not essential step of the present invention. The step S808 may provide a convenience to a user for easily indicating one of fingers in order to make a call to a desired party. However, the step S808 is not necessary step for setting the shortcut key because if the user remembers telephone numbers with matched fingerprints then the step S808 may not be necessary to be performed.

After displaying the list of the telephone numbers with images of the fingerprint data, it determines whether a fingerprint data is received from a fingerprint scanning sensor 130 at step S809.

If the fingerprint data is not received from the fingerprint scanning sensor 130 at step S809, a normal operation of the wireless communication terminal is performed at step S804.

If the fingerprint data is received from the fingerprint scanning sensor 130 at step S809, it determines whether there is any fingerprint data stored in the memory identical to the received fingerprint data at step S810.

If there is no fingerprint data in the memory identical to the received fingerprint data, an error message is displayed at a displayer 120 for informing no identical fingerprint data in the memory at step S806.

If there is a fingerprint data in the memory identical to the received fingerprint data, a call connection is established based on telephone number set to the identical fingerprint data in the memory by dialing the telephone number at step S811. In the step S811, the telephone number with the identical fingerprint data may be displayed at the displayer of the wireless communication terminal.

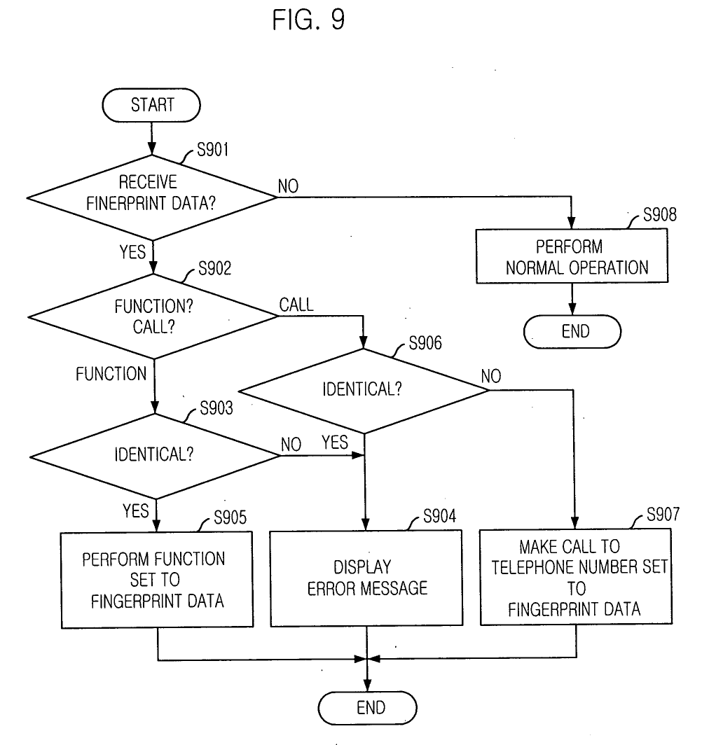

FIG. 9 is a flowchart showing a method for setting a shortcut key based on fingerprint recognition in accordance with a further still another preferred embodiment of the present invention.

Referring to FIG. 9, a controlling unit 203 of a wireless communication terminal 100 determines whether a fingerprint data is received from a fingerprint scanning sensor 130 at step S901.

Before the step S901, functions in a menu with set fingerprint data or a list of telephone numbers with set fingerprint data may be displayed at a displayer 120 of the wireless communication terminal 100. The reason of displaying was explained with the step 802 and the step 808 in FIG. 8.

If the fingerprint data is received at step S901, it determines whether a request signal for setting a shortcut key is a function request signal representing setting a predetermined function with a fingerprint data or a call request signal representing setting a predetermined telephone number with a fingerprint data at step S902.

If the request signal is the function request signal, it determines whether there is any fingerprint data stored in the memory 204 identical to the received fingerprint data at step S903.

If there is no an identical fingerprint data to the received fingerprint data, an error message is displayed at a displayer 120 of the wireless communication terminal 100 for informing no identical fingerprint data at step S904.

If there is an identical fingerprint data to the received fingerprint data, a function set to the identical fingerprint data is performed at step S905.

If the request signal is the call request signal, it determines whether there is an identical fingerprint data in the memory 204 to the received fingerprint data at step S906.

If there is no an identical fingerprint data to the received fingerprint data, an error message is displayed at the displayer 120 for informing no matched fingerprint data at step S904.

If there is an identical fingerprint data to the received fingerprint data, a call connection is established to the telephone number set to the identical fingerprint data at step S907. In the step S907, the telephone number with the received fingerprint data may be displayed at the displayer 120 for user's convenience.

If the fingerprint data is not received from the fingerprint scanning sensor at step S901, a normal operation of the wireless communication terminal 100 is performed at step S908.

The methods for setting the shortcut key shown in FIGS. 7 to 9 includes 3 to 5 times opportunities for re-entering the secret code or re-scanning a fingerprint when the fingerprint data or the secret code entered from the user are not matched with the fingerprint data and the secret code stored in a memory. If they are still mismatched after reentering or rescanning 3 to 5 times, an error message may be displayed.

As mentioned above, a user's convenience can be increased and functions of entertainments can be provided to a user by performing a predetermined function based on fingerprint recognition.

Also, the present invention can be used for preventing unauthorized use of the wireless communication terminal such as unauthorized use of making international calls.

The present invention contains subject matter related to Korean patent applications No. KR 2004-0039185 and No. KR 2003-0073405, filed in the Korean patent office on May 31, 2004 and on Oct. 21, 2003, the entire contents of which being incorporated herein by reference.

While the present invention has been described with respect to certain preferred embodiments, it will be apparent to those skilled in the art that various changes and modifications may be made without departing from the spirit and scope of the invention as defined in the following claims.

1. A method for setting a shortcut key based on fingerprint recognition, the method comprising the steps of:
a) activating a fingerprint registering menu according to a request signal of setting a shortcut key;
b) selecting a telephone number for setting the shortcut key to make a call when the request signal is a call request signal;
c) receiving a fingerprint data from a fingerprint scanning means by activating the fingerprint scanning means; and
d) storing the setting of the shortcut key including the selected telephone number and the received fingerprint data.

2. The method of claim 1, further comprising the steps of:
e) displaying functions in a menu when the request signal is a function request signal and selecting a predetermined function in the menu for setting the shortcut key to perform the predetermined function;
f) receiving the fingerprint data from the fingerprint scanning means by activating the fingerprint scanning means; and
g) storing the setting of the shortcut key including the selected predetermined function with the received fingerprint data.

3. The method of claim 2, the method further comprising:
h) displaying a list of telephone numbers and images of fingerprint data previously set to the telephone numbers in the list when the request signal is the call request signal; and
i) displaying the functions in the menu and images of fingerprint data previously set to the functions when the request signal is the function request signal.

4. A method for setting a shortcut key based on fingerprint recognition, the method comprising the steps of:
a) selecting one of telephone numbers in a list for setting a shortcut key to make a call to the selected telephone number;
b) activating a fingerprint registering menu according to a request signal of setting a shortcut key;
c) receiving a fingerprint data from a fingerprint scanning sensor by activating the fingerprint scanning sensor; and
d) storing a setting of the shortcut key including the selected telephone number and the received fingerprint data.

5. The method of claim 4, further comprising the step of:
e) displaying images of fingerprint data previously set to the telephone numbers in the list.

6. A method for setting a shortcut key based on fingerprint recognition, the method comprising the steps of:
a) displaying functions in a menu according to a menu selection signal and selecting a predetermined function in the menu for setting a shortcut key to perform the predetermined function;
b) activating a fingerprint registering menu according to a request signal of setting the shortcut key;
c) receiving a fingerprint data from a fingerprint scanning means by activating the fingerprint scanning means; and
d) storing the setting of the shortcut key including the selected predetermined function with the received fingerprint data.

7. The method of claim 6, further comprising the step of:
e) displaying images of fingerprint data previously set to the functions in the menu.

8. A method for setting a shortcut key based on fingerprint recognition, the method comprising the steps of:
a) receiving a fingerprint data from a fingerprint scanning means when a call request signal is received;
b) finding a fingerprint data identical to the received fingerprint data by comparing the received fingerprint data with stored fingerprint data in a memory; and
c) establishing a call connection based on the telephone number set to the stored fingerprint data identical to the received fingerprint data.

9. The method of claim 8, further comprising the steps of:
d) receiving the scanned fingerprint data from the fingerprint scanning means by receiving a function request signal;
e) finding a fingerprint data identical to the received fingerprint data by comparing the received fingerprint data with stored fingerprint data in the memory; and
f) performing a function set to the stored fingerprint data identical to the received fingerprint data.

10. The method of claim 9, further comprising the steps of:
g) displaying the telephone numbers in the list and images of fingerprint data previously set to the telephone numbers in the list when the call request signal is received; and
h) displaying the functions in the menu and images of fingerprint data previously set to the functions according to selecting the function setting request signal.

11. A method for setting a shortcut key based on fingerprint recognition, the method comprising the steps of:
a) determining whether a fingerprint data is received from a fingerprint scanning means when a call request signal is received in a locking mode;
b) receiving a secret code from an input means when the fingerprint data is not received, comparing the received secret code with a pre-stored secret code in a memory and displaying a list of telephone numbers when the received secret code is identical the pre-stored secret code;
c) finding a fingerprint data identical to the stored fingerprint data in the memory by comparing the received fingerprint data with stored fingerprint data when the fingerprint data is received; and
d) establishing a call connection to a telephone number set to the stored fingerprint data identical to the received fingerprint data.

12. The method of claim 11, further comprising the steps of:
e) determining whether a fingerprint data is received from a fingerprint scanning means when a function request signal is received in a locking mode;
f) inputting a secret code through an input means when the fingerprint data is not received;
g) finding a fingerprint data identical to the received fingerprint data by comparing the received fingerprint data with stored fingerprint data when the fingerprint data is received; and
h) performing a function set to the fingerprint data stored in the memory identical to the received fingerprint data.

13. The method of claim 12, further comprising the steps of:
i) displaying the telephone numbers of the list and images of fingerprint data set to the telephone number when the call request signal is received; and
j) displaying the functions in the menu and images of fingerprint data set to the functions when the function request signal is received.

14. A method for setting a shortcut key by using fingerprint recognition, the method comprising the steps of:
a) receiving a fingerprint data from a fingerprint scanning means;
b) finding a fingerprint data identical to the received fingerprint data among stored fingerprint data in a memory when a call request signal is received by comparing the received fingerprint data to stored fingerprint data in the memory; and
c) establishing a call connection by dialing a telephone number set to the found fingerprint data which is identical to the received fingerprint data among the stored fingerprint data.

15. The method of claim 14, further comprising the steps of:
d) finding a fingerprint data identical to the received fingerprint data among stored fingerprint data in a memory when a function request signal is received by comparing the received fingerprint data to stored fingerprint data in the memory; and
e) performing a function set to the found fingerprint data which is identical to the received fingerprint data among the stored fingerprint data.

16. The method of claim 15, further comprising the step of:
f) displaying telephone numbers in a list and images of fingerprint data set to the telephone numbers in the list, and functions in a menu and images of fingerprint data set to the functions.

17. A wireless communication terminal for setting a shortcut key based on fingerprint recognition, the wireless communication terminal comprising:
input means for receiving a request for setting a shortcut key based on fingerprint recognition;
fingerprint scanning means for scanning a fingerprint of a predetermined finger and generating a fingerprint data based on the scanned fingerprint;
storing means for storing a setting of a shortcut key including the fingerprint data received from the fingerprint scanning means and a predetermined function; and
controlling means for activating a fingerprint registering menu according to the request from the input means, selecting a predetermined telephone number to be set to the shortcut key when the request is a call request, set the shortcut key to match the selected telephone number with the fingerprint data received from the fingerprint means and storing a setting of the shortcut key including the selected telephone number with the fingerprint data received from the fingerprint scanning means.

18. The method of claim 17, wherein the controlling means for displaying functions in a menu when the request is a function request, selecting a predetermined function in the menu, setting the shortcut key to match the selected function with the fingerprint data received from the fingerprint means and storing a setting of the shortcut key including the selected function with the fingerprint data received from the fingerprint scanning means.

19. A wireless communication terminal for performing a predetermined function based on fingerprint recognition, comprising:
input means for receiving a request signal from a button;
fingerprint scanning means for scanning a fingerprint of a predetermined finger and generating a fingerprint data based on the scanned fingerprint;
storing means for storing settings of shortcut keys corresponding a plurality of fingerprint data received from the fingerprint scanning means; and
controlling means for activating the fingerprint scanning means when the request signal from the input means is a call request, receiving a current scanned fingerprint data from the fingerprint scanning means, and performing a shortcut key set to a fingerprint data stored in the storing means, which is identical to the current scanned fingerprint data, to make a call by dialing a telephone number set to the shortcut key

20. The method of claim 19, the controlling means for activating the fingerprint scanning means when the request signal from the input means is a function request, receiving a current scanned fingerprint data from the fingerprint scanning means, and performing a shortcut key set to a fingerprint data in the storing means, which is identical to the current scanned fingerprint data, to perform a function set to the shortcut key.

21. The method of claim 19, wherein the controlling means for finding the fingerprint data identical to the current scanned fingerprint data among the stored fingerprint data in the storing means by comparing the current scanned fingerprint data to the stored fingerprint data in the storing means, determining the shortcut key set to the found fingerprint data and making the call by dialing the telephone number set to the found shortcut key.

22. The method of claim 21, wherein the controlling means for finding the fingerprint data identical to the current scanned fingerprint data among the stored fingerprint data in the storing means by comparing the current scanned fingerprint data to the stored fingerprint data in the storing means, determining the shortcut key set to the found fingerprint data and performing the function set to the found shortcut key.
